(19) United States
(12) Patent Application Publication
(10) Pub. No.: US 2019/0166882 A1
(43) Pub. Date: Jun. 6, 2019

(54) RUMEN BYPASS COMPOSITION OF BIOLOGICALLY ACTIVE INGREDIENTS

(71) Applicant: Vivek Anand PARACHUR, Chennai (IN)

(72) Inventor: Vivek Anand PARACHUR, Chennai (IN)

(21) Appl. No.: 16/325,293

(22) PCT Filed: Aug. 12, 2017
(86) PCT No.: PCT/IN2017/050343

§ 371 Date: Feb. 13, 2019

(30) Foreign Application Priority Data
Aug. 13, 2016 (IN) 201641027750

(51) Int. Cl. A23K 40/35; A23K 50/10; A23K 20/158; A23K 40/10

(52) U.S. Cl. CPC A23K 40/35; A23K 50/10; A23K 20/20; A23K 40/10; A23K 20/158

(57) ABSTRACT

The present invention discloses rumen bypass composition containing rumen bypass coating/encapsulation matrix and biologically active substances. More particularly, the present invention discloses rumen stable/rumen bypass coating or encapsulation matrix for biologically active substances.

### FIELD OF INVENTION

The present invention discloses rumen bypass and thermally stable composition containing rumen bypass coating/encapsulation matrix and biologically active substances. More particularly, the present invention discloses rumen stable/rumen bypass coating or encapsulation matrix for biologically active substances.

### BACKGROUND AND PRIOR ART OF THE INVENTION

Rumen fermentation reduces the nutritive value of carbohydrates and proteins while destroying unsaturated lipids by hydrogenation and also degrade unprotected biologically active agents that are delivered orally to ruminants substantially by bacteria which contain fermentation enzymes.

In ruminant animals, such as cattle or sheep, the direct oral administration of biologically active substances, such as amino acids and vitamins, causes most of the substances to be decomposed in the rumen due to bacteria which contain fermentation enzymes; thus they are not effectively utilized/absorbed. Therefore, it is important to bypass the biologically active substances through the rumen without decomposition to allow the biologically active substances to be effectively digested and absorbed in the subsequent digestive tract, so as to improve the health and productivity of ruminants. For example, the bacteria in the rumen of a cow easily degrade or metabolize amino acids, like lysine and methionine into its by products and therefore, when the biomass reaches the intestine there are no amino acids remaining for the absorption by the animals.

The rumen is the largest of the four digestive chambers of ruminants and the microorganisms present in the rumen degrade the diet by fermentation process over a period of time from about 10 to 30 hours or longer. Most of the ingested protein material breaks down in the rumen to soluble peptides and amino acids that are used as nutrients by the rumen microorganisms. The rumen contents are passed into the subsequent digestive chambers along with the microorganisms. Once the contents dump into the abomasum and intestine, the microbial mass is digested, providing protein and amino acids to the ruminant. Therefore, the nutrients and medicaments shall be designed for use with ruminants must be protected against microbial action and the effects of pH, so that the active agent can remain bioavailable at the absorption site, thereby enabling the ruminant to increase its productivity such as increased quantity and improved quality of milk, meat etc.

There is ample literature available on methodologies that are designed to protect biological active ingredients such as amino acids, vitamins and minerals from ruminal degradation including heat and chemical treatment, encapsulation and coating, etc.

The earliest literature on these methodologies include U.S. Pat. No. 3,959,493 which discloses a rumen bypass system that uses aliphatic fatty acids having at least 14 carbon atoms, applied as a coating to the nutrient because the said fatty acids are resistant to rumen degradation. The active agents then are delivered to the abomasum and/or intestine where the fatty acids are reduced in that post-ruminal environment.

U.S. Pat. No. 5,093,128 describes a beadlet nutrient coating which includes fats and calcium based products. Coated ruminant nutrients have the disadvantage of cracking or abrading either in handling or in being masticated by the animal. Yet another U.S. Pat. No. 5,807,594 attempted to improve weight gain and feed efficiency in a ruminant by encapsulating a choline chloride composition in a rumen-protected carrier. The suitable encapsulating or coating materials for use in this invention include among others: hydrogenated oils, mono- and di-glycerides, waxes, and seed fats. All these encapsulation materials are thermally unstable.

US20020127259 suggests providing a composition comprising (i) a modified lecithin having the formula C8H17O5NRR′, wherein R and R′ are fatty acids having the formula CH3(CH2)nCOO, wherein n is between 4 and 22; and (ii) an active agent wherein said lecithin is present in an amount effective to protect said active agent from environmental oxidation.

As is evident from the foregoing, it has been proposed in the literature to coat ruminant animal feed additives containing biologically active substances with protective substances, such as higher melting point fatty acids, hardened animal oils and hardened vegetable oils. However, particles coated with these fats and oils are not only stable in the rumen, but also in the abomasum and subsequent digestive tract making the biologically active substances difficult to be released in the abomasum and subsequent digestive tract. The problems associated with these coating methods are costly, stability and suitability in mixing with feed, as they are sticky. They are also thermally unstable.

U.S. Pat. No. 4,808,412 reports a post-rumen effective composition for oral administration to ruminants containing a bioactive substance molecularly dispersed with a basic polymer.

In the light of the foregoing, there remains a need in the art to provide a thermally stable, rumen stable/rumen by pass coating or matrix for the delivery of biologically active substances, which is simple, cost effective, suitable, nonsticky, nonhygroscopic and delivers the active substance by bypassing the rumen.

### DESCRIPTION OF DRAWINGS

FIG. 1 depicts thermostability of coated product from the present invention in comparison with currently available product in the market in boiling water.

### SUMMARY OF THE INVENTION

In an aspect the invention provides a rumen bypass coating/matrix composition for encapsulating/embedding biologically active substance such as food/feed ingredients, pharmaceuticals, hormones, nutritional ingredients, nutraceutical, vitamins, minerals for ruminant animals/application and combination of these.

The rumen bypass composition according to the invention is stable in rumen and hence bypasses rumen, moving to next compartment in ruminant gut system. It is unstable in omasum and Abomasum, where the coating/matrix collapses and release biologically active ingredient for absorption. The composition of the present invention is nonsticky and nonhygroscopic, thermally stable which makes it suitable for application in feed. The composition of the present invention is also cost effective, as it involves low cost raw materials and easy manufacturing process.

The rumen bypass/stable coating/matrix according to the invention comprises of a coating/matrix forming compound/component, a hardening agent and optionally, an acid.

The coating/matrix forming components may be selected from an oleoresin, an oleo gum resin, gum resin, oils, vegetable oils, mineral oils, Rosin, lipids, fats, free fatty acids, sludge, Oleoresin spent, free fatty acid distillates and/or wax. The hardening agent is selected from metal hydroxide, metal oxide, metal carbonate, metal chloride, metal chelates and/or metal phosphates. The acid may optionally be selected from an organic acid or an inorganic acid.

In accordance with the above embodiment, the lipid component is selected from, but not limited to, by-products of oil refineries and phytochemical purifying industry such as Oleoresin Spent, Fatty Acids, Palm stearate (non hydrogenated and hydrogenated) Free Fatty Acid Distillate, Palm Fatty Acid Distillate, Sludge, Residue oil, Waxes and other lipid components.

The biologically active ingredient(s) may be selected from food/feed ingredients, pharmaceuticals, hormones, Biologics, vitamins, minerals, nutraceutical compounds/ingredients, nutritional compounds/ingredients, supplement/additives, and other beneficial ingredients and combinations of these.

In another aspect, the coating involved in the composition is single or multiple coatings to get the desirable protection of active ingredient in rumen.

In another aspect, the active ingredients are first granulated and then coated. The inactive ingredients/excipients may contain emulsifiers, solubilisers, bioavailability enhancers, slow release enhancers, stabilizers, antioxidants, including but not limited to succinic acid, maleic acid, humic acid, fumaric acid, buffers such as phosphate buffer, acetate buffer, antioxidant such as BHA, TBHQ, BHT other approved excipients either alone or in combination.

In another aspect, the invention provides an easier manufacturing process for preparation of rumen stable/rumen bypass composition.

### DETAILED DESCRIPTION OF INVENTION

The present invention relates to rumen stable/rumen by pass coating or matrix composition for embedding/encapsulating biologically active substances.

In an embodiment, the rumen bypass coating/matrix, in the final rumen by pass composition is the range of 0.5 to 99.5%.

In another embodiment, the biologically active ingredient/substance in the final rumen bypass composition is in the range of 0.5 to 99%.

The present invention describes a rumen bypass coating or matrix composition comprising a matrix forming compound/component, a hardening agent and, optionally, an acid.

Accordingly, rumen bypass coating or matrix composition for encapsulating/embedding biologically active substance comprising;
a) matrix forming compound/component in an amount of 0.5 to 99.50%;
b) hardening agent in an amount of 0.5 to 99.5%;
c) optionally an acid in an amount of 0.5 to 6%.

In an embodiment, the matrix forming compounds/component is selected from an oleoresin, oleoresin spent, an oleo gum resin, a gum resin, a resin, rosin, a lipid, a fat, fatty acids, fatty acid distillates, palm stearin, residue oil, sludge, oleoresin spent, mineral oils, vegetable oils, mother liquors and/or a wax or by-products of food and agricultural industries.

The matrix forming compound/component can be either in purified, semi-purified or crude extracts of plants and animals or by-product of the respective industries.

In accordance with the above embodiment, the oleoresin, oleo gum resin, gum resin, fatty acid distillates, wax or rosin is a crude or fractionated extract/byproduct of a plant selected from, but not limited to, Curcuma longa, Boswellia serrata, Bacopa monnieri, Marigold, Ginger, Glycyrrhiza glabra, Cinnamon species, Terminalia chebula, Scutellaria baicalensis, Pinus pinaster (Maritime pine bark), Euterpe oleracea, Acacia catechu, Silybum marianum, Viscum album, Punica granatum, Camellia sinensis (Green Tea), Green coffee bean, Commiphora (Mukul), Cassia fistula, Carica papaya, Centella asiatica, Cinnamomum zeylanicum, Cissus quadrangularis, Chlorophytum tuberosum, Curcuma zedoaria, Curcuma xanthorrhiza, Emblica officinalis, Eugenia jambolana, Eurycoma longifolia Root, Garcinia cambogia, Garcinia mangostana, Gymnema sylvestre, Indigofera tinctoria, Momordica charantia Fruit (Chamomile), Morinda citrifolia, Moringa oleifera, Mucuna pruriens, Piper nigrum Fruit, Phyllanthus niruri, Salacia oblonga, Salacia reticulata, Sphaeranthus indicus, Sida cordifolia, Tagetes erecta Flower, Tamarindus indica, Terminalia arjuna, Terminalia chebula, Tribulus terrestris, Trigonella foenum-graecum, Triphala, Ashwagandha, Resverarol, Hupericin, Acai, Bilberry, Raspberry, Cranberry, Grape Seed, Monagosteen, Noni, Olive, Pomegranate, Beet root, Copal resin, Commiphora myrrha resin, Pine resin, palm fatty acid distillate, sunflower fatty acid distillate, coconut oil sludge, coconut oil fatty acid distillate, rice bran wax, sunflower wax, residue oil, palm stearin, petroleum wax, paraffin wax, etc.

In accordance with the above embodiment, the lipid component is selected from, but not limited to, by-products of oil refineries and phytochemical purifying industry such as Oleoresin Spent, Fatty Acids, Free Fatty Acid Distillate, oils, mineral oils, vegetable oils, Palm Fatty Acid Distillate, sludge, palm stearin, Waxes from oil refineries such as rice bran wax, sunflower wax etc and other lipid components.

Preferably, the matrix forming compound/component is selected from palm fatty acid distillate or free fatty acids or palm stearin or rice bran wax.

In subsequent embodiment, the hardening agent is selected from, but not limited to, metal/mineral hydroxides/oxides/carbonates/chlorides/phosphates such as Calcium Hydroxide (Ca(OH)₂)/Calcium Oxide, Magnesium hydroxide (Mg(OH)₂)/Magnesium Oxide (MgO), Magnesium Chloride (MgCl₂), Zinc Hydroxide (Zn(OH)₂)/Zinc Oxide (ZnO) and Iron hydroxide (Fe(OH)₂)/Iron Oxide (FeO), Calcium Chloride (CaCl₂))/Calcium carbonate (CaCO₃), Magnesium chloride (MgCl₂)/Magnesium carbonate (MgCO₃), dicalcium phosphate, sodium hydroxide, potassium hydroxide. The most preferred metal salts being Calcium Hydroxide (Ca(OH)₂).

According to the present invention, the use of metal/mineral salt/hydroxide/oxide along with fatty acid results in hard coating layer, which is thermally stable. Moreover, the active ingredient will get coated during the process, thereby eliminating the possibility of cracking or abrading during handling or masticated by the animal.

The matrix/encapsulation forming natural compound forms a hard coating/matrix on biologically active substance upon reaction with metal/mineral salts and, optionally, acids. While hardening, the matrix embeds/coats the active ingredients during the process. The coating/matrix is not susceptible to microorganisms present in the rumen, pH and thus stable in rumen, which results in rumen bypass of the active. At the same time, the coating/matrix is unstable in omasum and abomasums, which results in release of active ingredient for absorption. The coating is also thermally stable, making it suitable for blending with feed before pelletization of feed.

In an optional embodiment, the coating/matrix contains an acid selected from, but not limited to, organic acids such as propionic acid, citric acid, fumaric acid, succinic acid, maleic acid and an inorganic acid such as hydrochloric acid and phosphoric acid.

In further embodiment, the rumen bypass coating/matrix composition of the invention may, optionally, contain pH modifiers, stabilizers, antioxidants, including but not limited to succinic acid, maleic acid, humic acid, fumaric acid, buffers such as phosphate buffer, acetate buffer, antioxidant such as BHA, TBHQ, BHT.

In an embodiment, the active ingredients are in solid (powder, granules, crystals), semisolid or in liquid form.

The active ingredient in accordance with above embodiment, may be selected from, but not limited to, a natural compound, a natural extract, a natural active compound, Phytochemicals, a pharmaceutical agent(s), hormones, a nutraceutical agent(s), feed supplements/additives, vaccines, biologics, nutritional ingredients, vitamins, minerals, growth promoters, performance enhancers, agrifoods ingredients, omega-3 fatty acids, omega-6-fatty acids, proteins, amino acids and all ingredient as required by ruminants. During the granulation, the excipients may be incorporated as described above.

The phytochemical containing component is selected from, but not limited to, solvent extract containing polyphenols, phenolic acids, flavonoids, Terpene, Sesqueterpenes, terpinoids, plant sterols, tannins, alkaloids, carotenes, pterostilbenes, ketones, quinones, amino acids, peptides, either alone or in combination.

The phytochemical is selected from, but not limited to, polyphenols, phenolic acids, flavonoid, Terpene, terpinoids, plant sterols, tannins, alkaloids, carotenes, pterostilbenes, quinones, amino acids, peptides either alone or in combination.

The phytochemical is selected from all hydrophobic and hydrophilic natural compounds, but not limited to, Lutein, Caffeine, Resveratrol, Berberin, 95% Curcuminoids, Gingerols, Bacosides, Boswellic Acids, Chlorogenic Acids, Xanthophils, Astaxanthin, Zeaxanthin, Fucoxanthin, Quercitin, Policosonals, Silymarin, Baicalin, Pycnogenol, Coenzyme Q10, Tocopherols either alone or in combination.

The vitamins are selected from but not limited to water soluble and fat soluble vitamins such as Vitamin A, Vitamin B (B1, B2, B3, B5, B6, B7, B9, B12), Vitamin C, Vitamin E, Vitamin D, Vitamin K1, Vitamin K2, Vitamin K7, Folic acid either alone or in combination.

The minerals are all macro and micro/trace minerals selected from but not limited to Calcium, Magnesium, Zinc, Iron, Selenium, Chromium, Manganese, Iodine, Cobalt, Copper, Phosphorous and their salts either alone or in combination.

The said biologically active ingredient are selected from but not limited to performance enhancers, hormones, growth supplements, nutrients, vitamins, minerals, proteins, amino acids such as Sodium Butyrate, Iodine, urea, Iron, calcium, chromium, selenium, lysine, methionine, Lysine, Amino acids: Methionine, Lysine, Proteins, Vitamins, Minerals, Enzymes, L-Carnitine etc all trace, micro, macro minerals, vitamins, drugs either alone or in combinations. Also includes all the ingredients requiring rumen bypass.

The said active ingredients are further selected from MSM, amino acids, Glucosamine, chondroitin sulphate, alpha lipoic acid, omega 3 fatty acids, free fatty acids, omega 6 fatty acids, MCTs, choline, Niacin, L-arginine, acetyl, L-carnitine, Glutathione.

In an embodiment, the active ingredients may either be solubilized in the encapsulation matrix or suspended uniformly in the matrix or single/double/multiple coated with the matrix. Most preferred is multiple coating. Coating can be done using the coating equipments/technologies currently available such as pan coater, fluid bed coater, planetary mixer, conventional coater, automated coating machines.

In another embodiment, the composition contains approved excipients such as wetting agents, flavours, sweetners, dispersing agents, glidents, flow property enhancers, preservatives, stabilizer, pH stabilizers, anti-oxidants etc.

In accordance with above embodiment, the rumen bypass matrix releases the active ingredients at low pH dissociation/hydrolysis in omasum and abomasum for subsequent absorption. Preferably, the active ingredient, which requires rumen bypass, is embedded/encapsulated in the matrix or coated during process of making the composition. The final formulation can be crystals, pellets, tablets, gels or granules. Most preferred formulation is granules.

In accordance with the above embodiment, the active ingredient which requires rumen bypass is coated with rumen bypass matrix or coating matrix during the process where coating can be single or multiple. Coating can be done using any coating equipments.

In a further embodiment, the composition of the invention is used for wellbeing, preventing and treating ruminant animals from various animal diseases. The composition can also be used for delivering the nutrients, pharmaceuticals, nutraceuticals, hormones, herbal preparations, omega-3-fatty acids, omega-6-fatty acids, proteins, amino acids, vitamins, minerals, performance enhancers, growth promoters, organic acids, fertility enhancers etc

The composition can be used for fortifying the animal products including but not limited to meat and milk with biologically active ingredients such as nutrients, nutraceuticals, phytochemicals such as Lutein, zeaxanthin, omega-3-fatty acids, omega-6-fatty acids, DHA, EPA, natural colors, flavours, amino acids, vitamins, minerals etc

In an embodiment, the composition of the invention can be formulated into solid, suspension, gel, granules, pellets, and semi solid formulations etc.

In an embodiment, the composition of the invention can be combined with other technologies for therapeutic and safety benefits such as to improve bioavailability, improve the therapeutic effect, reducing the dose, dose frequency, to increase the animal compliance.

In another embodiment, the invention provides a process for manufacturing the rumen bypass coating/matrix composition which comprises:
1) Cleaning the coating equipment/planetary mixer, and adding required amount of granular active ingredient;
2) Optionally, heating the content in the mixer from the step (1);
3) Adding the preheated encapsulation matrix/coating material into the coating equipment of step (2);
4) Optionally heating the contents;
5) Mixing well for uniform distribution of mixture from step (3);
6) Optionally adding the organic or inorganic acid to the mixture from step (5)
7) Adding hardening agent to the mixture of step (6) while mixing;
8) Mixing well to get the free flowing dry granules coated with coating material embedding the granular active ingredient;
9) Repeat step (1) to (7) for single or multiple times to get Rumen bypass granular product.

Note: Pre-granulation may be required for certain powder active ingredients, where it can be combined with required excipients.

In an alternative embodiment, the process for the manufacturing of rumen bypass coating/matrix composition which comprises:
a) adding required amount of biologically active substance (crystals or granules or pregranulated with excipients) into cleaned coating equipment;
b) Adding/spraying the optionally preheated, premix of coating/matrix forming components with an optional acid into the coating equipment of step (a);
c) Mixing well for uniform distribution of premix from step (b) on biologically active substance of step (a);
d) Adding/spraying hardening agent while mixing;
e) Mixing well to obtain the free flowing dry granules coated with matrix complex embedding active ingredients;
f) Repeating step (a) to (e) in case of double coating or multiple coatings to obtain rumen bypass coating/matrix composition.

In accordance with any of the above embodiments, the composition of invention can be prepared by using reactor, sigma mixers, planetary mixer, mixers, conventional coating equipment, granulators, pelletizer, extractor, extruders, powder spraying equipment, etc.

### Example 1

Composition of Methionine Formulation.

| | Ingredients | Composition (g) |
|---|---|---|
| 1 | Methionine | 60.0 |
| 2 | Palm fatty acid distillate/Palm stearin | 30.0 |
| 3 | Calcium hydroxide | 10.0 |

| | |
|---|---|
| Total | 100.0 |

Process for Manufacturing Rumen Bypass Methionine Formulation with Coating Equipment
1. Adding methionine granules to the coating equipment followed by starting the machine;
2. Slowly adding/spraying the palm fatty acid distillate/palm stearin to the contents of step (1);
3. Mixing well for uniform distribution of the contents of step (2);
4. Adding/spraying calcium hydroxide while mixing;
5. Mixing well to get the free flowing coated granules;
6. Sieving to remove excess calcium hydroxide; and
7. Filling into different HDPE containers or into suitable packaging material.

### Example 2

Composition of Methionine/Lysine Formulation: Double Coated Methionine/Lysine Formulation

Step a: First Coating

| | Ingredients | Composition (g) |
|---|---|---|
| 1 | Methionine/lysine | 60.0 |
| 2 | Palm fatty acid distillate | 30.0 |
| 3 | Calcium hydroxide | 10.0 |

| | |
|---|---|
| Total | 100.0 |

Process of Manufacturing Methionine/Lysine Formulation
1. Adding methionine/lysine granules to the coating equipment followed by starting the machine;
2. Slowly adding/spraying the preheated Palm fatty acid distillate to the contents of step (1);
3. Mixing well for uniform distribution of the contents of step (2);
4. Adding/spraying calcium hydroxide while mixing;
5. Mixing well to get the free flowing coated granules;
6. Sieving to remove excess calcium hydroxide;
7. Filling into different HDPE containers or into suitable packaging material for next coating.

Note: Rice bran wax can be used instead of Palm Fatty acid distillate

Step b: Second Coating—

| | Ingredients | Composition (g) |
|---|---|---|
| 1 | Methionine/lysine from Step (a) | 80.0 |
| | (Single coated granules) | |
| 2 | Palm fatty acid distillate/palm | 10.0 |
| | stearin | |
| 3 | Calcium hydroxide | 10.0 |

| | |
|---|---|
| Total | 100.0 |

1. Adding single coated methionine/lysine granules to the coating equipment followed by starting the machine;
2. Slowly adding/spraying the preheated Palm fatty acid distillate to the contents of step (1);
3. Mixing well for uniform distribution of the contents of step (2);
4. Adding/spraying calcium hydroxide while mixing;
5. Mixing well to get the free flowing coated granules;
6. Sieving the mix to remove excess calcium hydroxide;
7. Filling into different HDPE containers or into suitable packaging material.

Note: The step b) can be repeated for multiple coatings to achieve desirable rumen bypass

Final Composition for Double Coated Methionine:

| | Ingredients | Composition (g) |
|---|---|---|
| 1 | Methionine | 48 |
| 2 | Palm fatty acid distillate | 34 |
| 3 | Calcium hydroxide | 18 |

| | |
|---|---|
| Total | 100 |

### Example 3

Composition for Vitamin Formulation

| | Ingredients | Composition (g) |
|---|---|---|
| 1 | Niacin (pregranulated) | 60.0 |
| 2 | Palm fatty acid | 30.0 |
| | distillate/Palm stearin | |
| 3 | Calcium hydroxide | 10.0 |

| | |
|---|---|
| Total | 100.0 |

Process of Manufacturing Slow Release Niacin Formulation with Coating Equipment
1. Adding niacin granules to the coating equipment followed by starting the machine;
2. Slowly adding/spraying the palm fatty acid distillate to the contents of step (1);
3. Mixing well for uniform distribution of the contents of step (2);
4. Adding/spraying calcium hydroxide while mixing;
5. Mixing well to get the free flowing coated granules;
6. Sieving to remove excess calcium hydroxide; and
7. Filling into different HDPE containers or into suitable packaging material.

### Example 4

Composition of Niacin Formulation: Double Coated Niacin Formulation

Step a: First Coating

| | Ingredients | Composition (g) |
|---|---|---|
| 1 | Niacin (pregranulated) | 60.0 |
| 2 | Palm fatty acid | 30.0 |
| | distillate/Palm stearin | |
| 3 | Calcium hydroxide | 10.0 |

| | |
|---|---|
| Total | 100.0 |

Process of Manufacturing Slow Release Niacin Formulation
1. Adding niacin granules to the coating equipment followed by starting the machine;
2. Slowly adding/spraying the preheated Palm fatty acid distillate to the contents of step (1);
3. Mixing well for uniform distribution of the contents of step (2);
4. Adding/spraying calcium hydroxide while mixing;
5. Mixing well to get the free flowing coated granules;
6. Sieving to remove excess calcium hydroxide;
7. Filling into different HDPE containers or into suitable packaging material for next coating.

Note: Rice bran wax can be used instead of Palm Fatty acid distillate

Step b: Second Coating—

| | Ingredients | Composition (g) |
|---|---|---|
| 1 | Niacin (Single coated granules from | 80.0 |
| | step a) | |
| 2 | Palm fatty acid distillate/Pal stearin | 10.0 |
| 3 | Calcium hydroxide | 10.0 |

| | |
|---|---|
| Total | 100.0 |

1. Adding single coated Niacin granules (from step a) to the coating equipment followed by starting the machine;
2. Slowly adding/spraying the preheated Pal fatty acid distillate to the contents of step (1);
3. Mixing well for uniform distribution of the contents of step (2);
4. Adding/spraying calcium hydroxide while mixing;
5. Mixing well to get the free flowing coated granules;
6. Sieving the mix to remove excess calcium hydroxide;
7. Filling into different HDPE containers or into suitable packaging material.

Note: The step b) can be repeated for multiple coatings to achieve desirable rumen bypass

Final Composition for Double Coated Methionine:

| | | Composition (g) |
|---|---|---|
| | Ingredients | Formulation OLVP-03 |
| 1 | Niacin | 48 |
| 2 | Palm fatty acid | 34 |
| | distillate/Palm stearin | |
| 3 | Calcium hydroxide | 18 |

| | |
|---|---|
| Total | 100 |

### Example 5

Composition of EPA and DHA Formulation: Multiple Coating Coated EPA and DHA Formulation for Fortification of Meat and Milk.

Step a: First Coating

| | Ingredients | Composition (g) |
|---|---|---|
| 1 | EPA and DHA | 60.0 |
| | (pregranulated with | |
| | emulsifiers) | |
| 2 | Palm fatty acid | 30.0 |
| | distillate/Palm stearin | |
| 3 | Calcium hydroxide | 10.0 |

| | |
|---|---|
| Total | 100.0 |

Process of Manufacturing Slow Release EPA and DHA Formulation
1. Adding EPA and DHA granules to the coating equipment followed by starting the machine;
2. Slowly adding/spraying the preheated Palm fatty acid distillate to the contents of step (1);
3. Mixing well for uniform distribution of the contents of step (2);
4. Adding/spraying calcium hydroxide while mixing;
5. Mixing well to get the free flowing coated granules;
6. Sieving to remove excess calcium hydroxide;
7. Filling into different HDPE containers or into suitable packaging material for next coating.

Note: Rice bran wax can be used instead of Palm Fatty acid distillate

Step b: Second Coating:

| | Ingredients | Composition (g) |
|---|---|---|
| 1 | EPA and DHA (Single coated | 80.0 |
| | granules from step. a) | |
| 2 | Palm fatty acid distillate/Palm | 10.0 |
| | stearin | |
| 3 | Calcium hydroxide | 10.0 |

| | |
|---|---|
| Total | 100.0 |

1. Adding single coated EPA and DHA (from step.a) to the coating equipment followed by starting the machine;
2. Slowly adding/spraying the preheated Pal fatty acid distillate to the contents of step (1);
3. Mixing well for uniform distribution of the contents of step (2);
4. Adding/spraying calcium hydroxide while mixing;
5. Mixing well to get the free flowing coated granules;
6. Sieving the mix to remove excess calcium hydroxide;
7. Filling into different HDPE containers or into suitable packaging material.

Note: The step b) can be repeated for multiple coatings to achieve desirable rumen bypass

Final Composition for Double Coated Methionine:

| | Ingredients | Composition (g) |
|---|---|---|
| 1 | EPA and DHA | 48 |
| 2 | Palm fatty acid distillate | 34 |
| 3 | Calcium hydroxide | 18 |

| | |
|---|---|
| Total | 100 |

### Example 6

Multi Coated Composition of Methionine Rumen Bypass

| | | |
|---|---|---|
| S. NO | Ingredients | Quantity (g)/100 g |

1st coating

| | | |
|---|---|---|
| 1 | Methionine | 91.50 |
| 2 | Palm Stearin/Fatty acid | 2.75 |
| 3 | Calcium Hydroxide | 5.75 |
| | Total | 100.00 |

2nd coating

| | | |
|---|---|---|
| 1 | Single Coated methionine | 91.50 |
| 2 | Palm Stearin/Fatty acid | 2.75 |
| 3 | Calcium Hydroxide | 5.75 |
| | Total | 100.00 |

3rd coating

| | | |
|---|---|---|
| 1 | Double Coated methionine | 91.50 |
| 2 | Palm Stearin/Fatty acid | 2.75 |
| 3 | Calcium Hydroxide | 5.75 |
| | Total | 100.00 |

4th coating

| | | |
|---|---|---|
| 1 | Triple coated methionine | 91.50 |
| 2 | Palm Stearin/Fatty acid | 2.75 |
| 3 | Calcium Hydroxide | 5.75 |
| | Total | 100.00 |

5th coating

| | | |
|---|---|---|
| 1 | methionine coated for 4 times | 91.50 |
| 2 | Palm Stearin/Fatty acid | 2.75 |
| 3 | Calcium Hydroxide | 5.75 |
| | Total | 100.00 |

Final Composition

| | | |
|---|---|---|
| 1 | Methionine | 64.14 |
| 2 | Palm Stearin/Fatty acid | 11.60 |
| 3 | Calcium Hydroxide | 24.26 |
| | Total | 100.00 |

Process for Manufacture of Multicoated Methionine Rumen Bypass Formulation:
1. adding required amount of methionine granule to a cleaned coating equipment/planetary mixer;
2. Optionally, heating the contents of step (1);
3. Adding the preheated palm stearin/fatty acid into the contents of step (2);
4. Optionally heating the contents of step (3);
5. Mixing well for uniform distribution of the contents of step (4);
6. Adding calcium hydroxide while mixing;
7. Mixing well to get the free flowing dry granules coated with coating material embedding methionine;
8. Repeating step (1) to (7) for five times to get Methionine Rumen bypass multicoated granular product.

Testing for Stability of Granules:

The granules are expected to be stable without releasing the active ingredient for 8 hrs (retaining time of the feed in Rumen). Stability of methionine granules in water (considering the pH of rumen, which is 6.5 to 7) was done by adding methionine rumen bypass formulation at concentration 1 mg/ml in water at continuous stirring at 50 RPM. Sample was collected at regular intervals (0, 1, 2, 3, 4, 5, 6, 7, 8 hrs) and analysed for methionine content. No release of active ingredient observed upto 8 hours.

### Example 7: Composition of Multicoated Lysine Rumen Bypass by Using the Procedure as Described Under Example 6

| | | |
|---|---|---|
| S. NO | Ingredients | Quantity (g)/100 g |

1st coating

| | | |
|---|---|---|
| 1 | Lysine | 91.50 |
| 2 | Palm Stearin/Fatty acid | 2.75 |
| 3 | Calcium Hydroxide | 5.75 |
| | Total | 100.00 |

2nd coating

| | | |
|---|---|---|
| 1 | Single Coated Lysine | 91.50 |
| 2 | Palm Stearin/Fatty acid | 2.75 |
| 3 | Calcium Hydroxide | 5.75 |
| | Total | 100.00 |

3rd coating

| | | |
|---|---|---|
| 1 | Double Coated Lysine | 91.50 |
| 2 | Palm Stearin/Fatty acid | 2.75 |
| 3 | Calcium Hydroxide | 5.75 |
| | Total | 100.00 |

4th coating

| | | |
|---|---|---|
| 1 | Triple coated Lysine | 91.50 |
| 2 | Palm Stearin/Fatty acid | 2.75 |
| 3 | Calcium Hydroxide | 5.75 |
| | Total | 100.00 |

5th coating

| | | |
|---|---|---|
| 1 | Lysine coated for 4 times | 91.50 |
| 2 | Palm Stearin/Fatty acid | 2.75 |
| 3 | Calcium Hydroxide | 5.75 |
| | Total | 100.00 |

Final Composition

| | | |
|---|---|---|
| 1 | Lysine | 64.14 |
| 2 | Palm Stearin/Fatty acid | 11.60 |
| 3 | Calcium Hydroxide | 24.26 |
| | Total | 100.00 |

Testing for Stability of Granules:

The granules are expected to be stable without releasing the active ingredient for 8 hrs (retaining time of the feed in Rumen). Stability of Lysine granules in water was done by adding Lysine rumen bypass formulation at concentration 1 mg/ml in water at continuous stirring at 50 RPM. Sample was collected at regular intervals (0, 1, 2, 3, 4, 5, 6, 7, 8 hrs) and analysed for Lysine content. No release of active ingredient observed upto 8 hours.

### Example 8: Composition of Sodium Butyrate Rumen Bypass

| | | |
|---|---|---|
| S. NO | Ingredients | Quantity (g)/100 g |

1st coating

| | | |
|---|---|---|
| 1 | sodium butyrate | 83.00 |
| 2 | Palm Stearin/Fatty acid | 5.50 |
| 3 | Calcium Hydroxide | 11.50 |
| | Total | 100.00 |

2nd coating

| | | |
|---|---|---|
| 1 | Single Coated sodium butyrate | 83.00 |
| 2 | Palm Stearin/Fatty acid | 5.50 |
| 3 | Calcium Hydroxide | 11.50 |
| | Total | 100.00 |

3rd coating

| | | |
|---|---|---|
| 1 | Double Coated sodium butyrate | 83.00 |
| 2 | Palm Stearin/Fatty acid | 5.50 |
| 3 | Calcium Hydroxide | 11.50 |
| | Total | 100.00 |

4th coating

| | | |
|---|---|---|
| 1 | Triple coated sodium butyrate | 83.00 |
| 2 | Palm Stearin/Fatty acid | 5.50 |
| 3 | Calcium Hydroxide | 11.50 |
| | Total | 100.00 |

5th coating

| | | |
|---|---|---|
| 1 | sodium butyrate coated for 4 times | 83.00 |
| 2 | Palm Stearin/Fatty acid | 5.50 |
| 3 | Calcium Hydroxide | 11.50 |
| | Total | 100.00 |

Final Composition

| | | |
|---|---|---|
| 1 | sodium butyrate | 39.39 |
| 2 | Palm Stearin/Fatty acid | 19.61 |
| 3 | Calcium Hydroxide | 41.00 |
| | Total | 100.00 |

Testing for Stability of Granules:

The granules are expected to be stable without releasing the active ingredient for 8 hrs (retaining time of the feed in Rumen). Stability of Sodium Butyrate granules in water was done by adding Sodium Butyrate rumen bypass formulation at concentration 1 mg/ml in water at continuous stirring at 50 RPM. Sample was collected at regular intervals (0, 1, 2, 3, 4, 5, 6, 7, 8 hrs) and analysed for Sodium Butyrate content. No release of active ingredient observed upto 8 hours. This indicates that, the product will be stable in rumen for 8 hrs.

### Example 9: Composition of Lutein Rumen Bypass

| | | |
|---|---|---|
| S.NO | Ingredients | Quantity (g)/100g |

1st coating

| | | |
|---|---|---|
| 1 | Lutein | 83.00 |
| 2 | Palm Stearin/Fatty acid | 5.50 |
| 3 | Calcium Hydroxide | 11.50 |
| | Total | 100.00 |

2nd coating

| | | |
|---|---|---|
| 1 | Single Coated lutein | 83.00 |
| 2 | Palm Stearin/Fatty acid | 5.50 |
| 3 | Calcium Hydroxide | 11.50 |
| | Total | 100.00 |

3rd coating

| | | |
|---|---|---|
| 1 | Double Coated lutein | 83.00 |
| 2 | Palm Stearin/Fatty acid | 5.50 |
| 3 | Calcium Hydroxide | 11.50 |
| | Total | 100.00 |

4th coating

| | | |
|---|---|---|
| 1 | Triple coated lutein | 83.00 |
| 2 | Palm Stearin/Fatty acid | 5.50 |
| 3 | Calcium Hydroxide | 11.50 |
| | Total | 100.00 |

5th coating

| | | |
|---|---|---|
| 1 | lutein coated for 4 times | 83.00 |
| 2 | Palm Stearin/Fatty acid | 5.50 |
| 3 | Calcium Hydroxide | 11.50 |
| | Total | 100.00 |

Final Composition

| | | |
|---|---|---|
| 1 | Lutein | 39.39 |
| 2 | Palm Stearin/Fatty acid | 19.61 |
| 3 | Calcium Hydroxide | 41.00 |
| | Total | 100.00 |

Testing for Stability of Granules:

The granules are expected to be stable without releasing the active ingredient for 8 hrs (retaining time of the feed in Rumen). Stability of Lutein granules in water was done by adding Lutein rumen bypass formulation at concentration 1 mg/ml in water at continuous stirring at 50 RPM. Sample was collected at regular intervals (0, 1, 2, 3, 4, 5, 6, 7, 8 hrs) and analysed for Lutein content. No release of active ingredient observed upto 8 hours. This indicates that, the product will be stable in rumen for 8 hrs.

### Example 10: Composition of Vitamin B12 Rumen Bypass

| | | |
|---|---|---|
| S. NO | Ingredients | Quantity (g)/100 g |

1st coating

| | | |
|---|---|---|
| 1 | vitamin B12 | 83.00 |
| 2 | Palm Stearin/Fatty acid | 5.50 |
| 3 | Calcium Hydroxide | 11.50 |
| | Total | 100.00 |

2nd coating

| | | |
|---|---|---|
| 1 | Single Coated vitamin B12 | 83.00 |
| 2 | Palm Stearin/Fatty acid | 5.50 |
| 3 | Calcium Hydroxide | 11.50 |
| | Total | 100.00 |

3rd coating

| | | |
|---|---|---|
| 1 | Double Coated vitamin B12 | 83.00 |
| 2 | Palm Stearin/Fatty acid | 5.50 |
| 3 | Calcium Hydroxide | 11.50 |
| | Total | 100.00 |

4th coating

| | | |
|---|---|---|
| 1 | Triple coated vitamin B12 | 83.00 |
| 2 | Palm Stearin/Fatty acid | 5.50 |
| 3 | Calcium Hydroxide | 11.50 |
| | Total | 100.00 |

5th coating

| | | |
|---|---|---|
| 1 | vitamin B12 coated for 4 times | 83.00 |
| 2 | Palm Stearin/Fatty acid | 5.50 |
| 3 | Calcium Hydroxide | 11.50 |
| | Total | 100.00 |

Final Composition

| | | |
|---|---|---|
| 1 | vitamin B12 | 39.39 |
| 2 | Palm Stearin/Fatty acid | 19.61 |
| 3 | Calcium Hydroxide | 41.00 |
| | Total | 100.00 |

Testing for Stability of Granules:

The granules are expected to be stable without releasing the active ingredient for 8 hrs (retaining time of the feed in Rumen). Stability of Vitamin B12 granules in water was done by adding Vitamin B12 rumen bypass formulation at concentration 1 mg/ml in water at continuous stirring at 50 RPM. Sample was collected at regular intervals (0, 1, 2, 3, 4, 5, 6, 7, 8 hrs) and analysed for Vitamin B12 content. No release of active ingredient observed upto 8 hours. This indicates that, the product will be stable in rumen for 8 hrs.

### Example 11: Composition of Calcium Rumen Bypass

| | | |
|---|---|---|
| S. NO | Ingredients | Quantity (g)/100 g |

1st coating

| | | |
|---|---|---|
| 1 | Dibasic calcium phosphate | 83.00 |
| 2 | Palm Stearin/Fatty acid | 5.50 |
| 3 | Calcium Hydroxide | 11.50 |
| | Total | 100.00 |

2nd coating

| | | |
|---|---|---|
| 1 | Single Coated Dibasic calcium | 83.00 |
| | phosphate | |
| 2 | Palm Stearin/Fatty acid | 5.50 |
| 3 | Calcium Hydroxide | 11.50 |
| | Total | 100.00 |

3rd coating

| | | |
|---|---|---|
| 1 | Double Coated Dibasic calcium | 83.00 |
| | phosphate | |
| 2 | Palm Stearin/Fatty acid | 5.50 |
| 3 | Calcium Hydroxide | 11.50 |
| | Total | 100.00 |

4th coating

| | | |
|---|---|---|
| 1 | Triple coated Dibasic calcium | 83.00 |
| | phosphate | |
| 2 | Palm Stearin/Fatty acid | 5.50 |
| 3 | Calcium Hydroxide | 11.50 |
| | Total | 100.00 |

5th coating

| | | |
|---|---|---|
| 1 | Dibasic calcium phosphate coated for 4 | 83.00 |
| | times | |
| 2 | Palm Stearin/Fatty acid | 5.50 |
| 3 | Calcium Hydroxide | 11.50 |
| | Total | 100.00 |

Final Composition

| | | |
|---|---|---|
| 1 | Dibasic calcium phosphate | 39.39 |
| 2 | Palm Stearin/Fatty acid | 19.61 |
| 3 | Calcium Hydroxide | 41.00 |
| | Total | 100.00 |

Testing for Stability of Granules:

The granules are expected to be stable without releasing the active ingredient for 8 hrs (retaining time of the feed in Rumen). Stability of Calcium granules in water was done by adding Calcium rumen bypass formulation at concentration 1 mg/ml in water at continuous stirring at 50 RPM. Sample was collected at regular intervals (0, 1, 2, 3, 4, 5, 6, 7, 8 hrs) and analysed for Calcium content. No release of active ingredient observed upto 8 hours. This indicates that, the product will be stable in rumen for 8 hrs.

### Example 12: Composition of Citric Acid Rumen Bypass

| | | |
|---|---|---|
| S. NO | Ingredients | Quantity (g)/100 g |

1st coating

| | | |
|---|---|---|
| 1 | citric acid | 83.00 |
| 2 | Palm Stearin/Fatty acid | 5.50 |
| 3 | Calcium Hydroxide | 11.50 |
| | Total | 100.00 |

2nd coating

| | | |
|---|---|---|
| 1 | Single Coated citric acid | 83.00 |
| 2 | Palm Stearin/Fatty acid | 5.50 |
| 3 | Calcium Hydroxide | 11.50 |
| | Total | 100.00 |

3rd coating

| | | |
|---|---|---|
| 1 | Double Coated citric acid | 83.00 |
| 2 | Palm Stearin/Fatty acid | 5.50 |
| 3 | Calcium Hydroxide | 11.50 |
| | Total | 100.00 |

4th coating

| | | |
|---|---|---|
| 1 | Triple coated citric acid | 83.00 |
| 2 | Palm Stearin/Fatty acid | 5.50 |
| 3 | Calcium Hydroxide | 11.50 |
| | Total | 100.00 |

5th coating

| | | |
|---|---|---|
| 1 | citric acid coated for 4 times | 83.00 |
| 2 | Palm Stearin/Fatty acid | 5.50 |
| 3 | Calcium Hydroxide | 11.50 |
| | Total | 100.00 |

Final Composition

| | | |
|---|---|---|
| 1 | citric acid | 39.39 |
| 2 | Palm Stearin/Fatty acid | 19.61 |
| 3 | Calcium Hydroxide | 41.00 |
| | Total | 100.00 |

Testing for Stability of Granules:

The granules are expected to be stable without releasing the active ingredient for 8 hrs (retaining time of the feed in Rumen). Stability of Citric acid granules in water was done by adding Citric acid rumen bypass formulation at concentration 1 mg/ml in water at continuous stirring at 50 RPM. Sample was collected at regular intervals (0, 1, 2, 3, 4, 5, 6, 7, 8 hrs) and analysed for Citric acid content. No release of active ingredient observed upto 8 hours. This indicates that, the product will be stable in rumen for 8 hrs.

### Example 13: Composition of Organic Acids Rumen Bypass

TABLE-VII

| | | |
|---|---|---|
| S. NO | Ingredients | Quantity (g)/100 g |

1st coating

| | | |
|---|---|---|
| 1 | Blend of organic acids (fumaric acid, | 83.00 |
| | citric acid, malic acid, capric and caprylic | |
| | acid) (Granular) | |
| 2 | Palm Stearin/Fatty acid | 5.50 |
| 3 | Calcium Hydroxide | 11.50 |
| | Total | 100.00 |

2nd coating

| | | |
|---|---|---|
| 1 | Single Coated Blend of organic acids | 83.00 |
| 2 | Palm Stearin/Fatty acid | 5.50 |
| 3 | Calcium Hydroxide | 11.50 |
| | Total | 100.00 |

3rd coating

| | | |
|---|---|---|
| 1 | Double Coated Blend of organic acids | 83.00 |
| 2 | Palm Stearin/Fatty acid | 5.50 |
| 3 | Calcium Hydroxide | 11.50 |
| | Total | 100.00 |

4th coating

| | | |
|---|---|---|
| 1 | Triple coated Blend of organic acids | 83.00 |
| 2 | Palm Stearin/Fatty acid | 5.50 |
| 3 | Calcium Hydroxide | 11.50 |
| | Total | 100.00 |

5th coating

| | | |
|---|---|---|
| 1 | Blend of organic acids coated for 4 | 83.00 |
| | times | |
| 2 | Palm Stearin/Fatty acid | 5.50 |
| 3 | Calcium Hydroxide | 11.50 |
| | Total | 100.00 |

Final Composition

| | | |
|---|---|---|
| 1 | Blend of organic acids | 39.39 |
| 2 | Palm Stearin/Fatty acid | 19.61 |
| 3 | Calcium Hydroxide | 41.00 |
| | Total | 100.00 |

Testing for Stability of Granules:

The granules are expected to be stable without releasing the active ingredient for 8 hrs (retaining time of the feed in Rumen). Stability of Blend of organic acids granules in water was done by adding Blend of organic acids rumen bypass formulation at concentration 1 mg/ml in water at continuous stirring at 50 RPM. Sample was collected at regular intervals (0, 1, 2, 3, 4, 5, 6, 7, 8 hrs) and analysed for each organic acids content. No release of active ingredient observed upto 8 hours. This indicates that, the product will be stable in rumen for 8 hrs.

### Example 14: Composition of Omega 3 Fatty Acid Rumen Bypass

| | | |
|---|---|---|
| S. NO | Ingredients | Quantity (g)/100 g |

1st coating

| | | |
|---|---|---|
| 1 | Omega 3 fatty acid (Granular) | 91.50 |
| 2 | Palm Stearin/Fatty acid | 2.75 |
| 3 | Calcium Hydroxide | 5.75 |
| | Total | 100.00 |

2nd coating

| | | |
|---|---|---|
| 1 | Single Coated Omega 3 fatty acid | 91.50 |
| 2 | Palm Stearin/Fatty acid | 2.75 |
| 3 | Calcium Hydroxide | 5.75 |
| | Total | 100.00 |

3rd coating

| | | |
|---|---|---|
| 1 | Double Coated Omega 3 fatty acid | 91.50 |
| 2 | Palm Stearin/Fatty acid | 2.75 |
| 3 | Calcium Hydroxide | 5.75 |
| | Total | 100.00 |

4th coating

| | | |
|---|---|---|
| 1 | Triple coated Omega 3 fatty acid | 91.50 |
| 2 | Palm Stearin/Fatty acid | 2.75 |
| 3 | Calcium Hydroxide | 5.75 |
| | Total | 100.00 |

5th coating

| | | |
|---|---|---|
| 1 | Omega 3 fatty acid coated for 4 times | 91.50 |
| 2 | Palm Stearin/Fatty acid | 2.75 |
| 3 | Calcium Hydroxide | 5.75 |
| | Total | 100.00 |

Final Composition

| | | |
|---|---|---|
| 1 | Omega 3 fatty acid | 64.14 |
| 2 | Palm Stearin/Fatty acid | 11.60 |
| 3 | Calcium Hydroxide | 24.26 |
| | Total | 100.00 |

Testing for Stability of Granules:

The granules are expected to be stable without releasing the active ingredient for 8 hrs (retaining time of the feed in Rumen). Stability of Omega 3 fatty acid granules in water was done by adding Omega 3 fatty acid rumen bypass formulation at concentration 1 mg/ml in water at continuous stirring at 50 RPM. Sample was collected at regular intervals (0, 1, 2, 3, 4, 5, 6, 7, 8 hrs) and analysed for Omega 3 fatty acid content. No release of active ingredient observed upto 8 hours. This indicates that, the product will be stable in rumen for 8 hrs.

### Example 15: Composition of Choline/Protein Rumen Bypass

| | | |
|---|---|---|
| S. NO | Ingredients | Quantity (g)/100 g |

1st coating

| | | |
|---|---|---|
| 1 | Choline/Protein (Granular) | 91.50 |
| 2 | Palm Stearin/Fatty acid | 2.75 |
| 3 | Calcium Hydroxide | 5.75 |
| | Total | 100.00 |

2nd coating

| | | |
|---|---|---|
| 1 | Single Coated Choline/Protein | 91.50 |
| 2 | Palm Stearin/Fatty acid | 2.75 |
| 3 | Calcium Hydroxide | 5.75 |
| | Total | 100.00 |

3rd coating

| | | |
|---|---|---|
| 1 | Double Coated Choline/Protein | 91.50 |
| 2 | Palm Stearin/Fatty acid | 2.75 |
| 3 | Calcium Hydroxide | 5.75 |
| | Total | 100.00 |

4th coating

| | | |
|---|---|---|
| 1 | Triple coated Choline/Protein | 91.50 |
| 2 | Palm Stearin/Fatty acid | 2.75 |
| 3 | Calcium Hydroxide | 5.75 |
| | Total | 100.00 |

5th coating

| | | |
|---|---|---|
| 1 | Choline/Protein coated for 4 times | 91.50 |
| 2 | Palm Stearin/Fatty acid | 2.75 |
| 3 | Calcium Hydroxide | 5.75 |
| | Total | 100.00 |

Final Composition

| | | |
|---|---|---|
| 1 | Choline/Protein | 64.14 |
| 2 | Palm Stearin/Fatty acid | 11.60 |
| 3 | Calcium Hydroxide | 24.26 |
| | Total | 100.00 |

Testing for Stability of Granules:

The granules are expected to be stable without releasing the active ingredient for 8 hrs (retaining time of the feed in Rumen). Stability of Choline/Protein granules in water was done by adding Choline/Protein rumen bypass formulation at concentration 1 mg/ml in water at continuous stirring at 50 RPM. Sample was collected at regular intervals (0, 1, 2, 3, 4, 5, 6, 7, 8 hrs) and analysed for Choline/Protein content. No release of active ingredient observed upto 8 hours. This indicates that, the product will be stable in rumen for 8 hrs.

### Example 16: Composition of Methionine Rumen Bypass

| | | |
|---|---|---|
| S. NO | Ingredients | Quantity (g)/100 g |

1st coating

| | | |
|---|---|---|
| 1 | Methionine | 91.50 |
| 2 | Palm Stearin/Fatty acid | 2.75 |
| 3 | Calcium Hydroxide | 5.75 |
| | Total | 100.00 |

2nd coating

| | | |
|---|---|---|
| 1 | Single Coated methionine | 91.50 |
| 2 | Palm Stearin/Fatty acid | 2.75 |
| 3 | Calcium Hydroxide | 5.75 |
| | Total | 100.00 |

3rd coating

| | | |
|---|---|---|
| 1 | Double Coated methionine | 91.50 |
| 2 | Palm Stearin/Fatty acid | 2.75 |
| 3 | Calcium Hydroxide | 5.75 |
| | Total | 100.00 |

4th coating

| | | |
|---|---|---|
| 1 | Triple coated methionine | 91.50 |
| 2 | Palm Stearin/Fatty acid | 2.75 |
| 3 | Calcium Hydroxide | 5.75 |
| | Total | 100.00 |

Final Composition

| | | |
|---|---|---|
| 1 | Methionine | 70.10 |
| 2 | Palm Stearin/Fatty acid | 9.68 |
| 3 | Calcium Hydroxide | 20.22 |
| | Total | 100.00 |

Thermostability of the Vitamin Formulation:

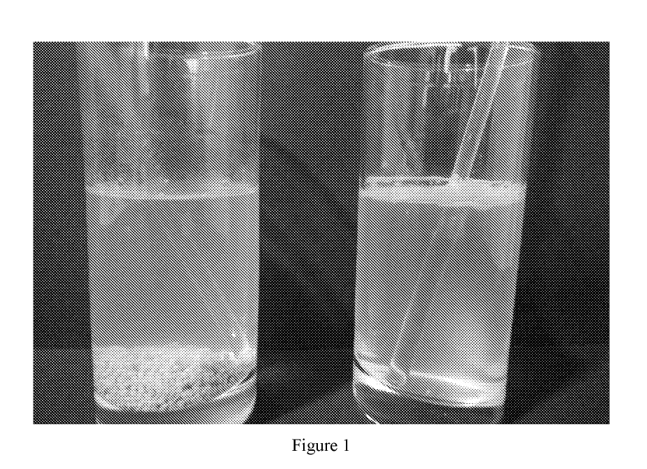

The thermostability of coated product from the present invention was tested in comparison to currently available product in the market (FIG. 1). Known amount of products were taken in a separate glass container and boiling water was added to both the products. The results shows that, the product from present invention was stable and the currently available product is not. Thermostability enables the product to be used in pelletization of the feed, where the feed will be passed through extruder with high temperature (70 to 90° C.) and steam. The ubstable products will release the active ingredients during pelletization and hence not suitable.

1. A rumen bypass coating or matrix composition for encapsulating or embedding a biologically active substance, comprising:
a) a matrix forming compound/component in an amount of 0.5 to 99.5%;
b) a hardening agent in an amount of 0.5 to 99.5%; and
c) an acid in an amount of 0 to 6%;
wherein the composition is rumen stable, thermostable, nonsticky, nonhygroscopic and bypasses a rumen, and
wherein the composition is unstable in an omasum and an abomasum, where the coating or matrix composition collapses and releases the biologically active ingredient for absorption.

2. The Rumen bypass coating or matrix composition according to claim 1, wherein, the matrix forming compound/component is selected from the group consisting of an oleoresin, spent oleoresin, an oleo gum resin, a gum resin, a resin, rosin, a lipid, a fat, fatty acids, fatty acid distillates, sludge, residue oil, oleoresin spent, mineral oils, vegetable oils, mother liquors, a wax, by-products of food and agricultural industries, and a mixture thereof.

3. The Rumen bypass coating or matrix composition according to claim 2, wherein the matrix forming compound/component is selected from the group consisting of a palm fatty acid distillate, a free fatty acid, a hydrogenated or nonhydrogenated palm stearate, a residue oil, a wax, and a mixture thereof.

4. The Rumen bypass coating or matrix composition according to claim 1, wherein the hardening agent is selected from the group consisting of a metal/mineral hydroxide, a metal/mineral oxide, a metal/mineral carbonate, a metal/mineral chloride, a metal/mineral chelate, and a metal/mineral phosphate.

5. The Rumen bypass coating or matrix composition according to claim 1, wherein the acid is:
an organic acid selected from the group consisting of propionic acid, citric acid, fumaric acid, succinic acid, and maleic acid; or
an inorganic acid selected from the group consisting of hydrochloric acid and phosphoric acid.

6. The Rumen bypass coating or matrix composition according to claim 1, wherein, the biologically active substance is selected from the group consisting of food/feed ingredients, pharmaceuticals, hormones, Biologics, phytochemicals, phytochemical containing components, vitamins, minerals, nutraceutical compounds/ingredients, nutritional compounds/ingredients, supplement/additives, animal extract, food ingredients, beverage ingredients, growth promoters, performance enhancers, omega-3 fatty acids, omega-6-fatty acids, proteins, amino acids, and mixtures thereof.

7. (canceled)

8. The Rumen bypass coating or matrix composition according to claim 1, wherein the composition is formulated into a solid formulation, a suspension formulation, a gel formulation, a granular formulation, a formulation of pellets, or a semi-solid formulation.

9. (canceled)

10. (canceled)

11. A process for manufacturing a rumen bypass coating or matrix composition, comprising:
a) adding a required amount of granular active ingredient to a coating equipment;
b) Adding a preheated encapsulation matrix forming compound/component into the coating equipment of step (a);
c) Mixing the mixture from step (b);
d) optionally adding an organic or inorganic acid to the mixture from step (c)
e) Adding a hardening agent to the mixture of step (d) while mixing;
f) Mixing the mixture of step (e) to obtain free flowing dry granules coated with a first coating of the rumen bypass coating or matrix composition embedding the granular active ingredient.

12. A process for manufacturing a rumen bypass coating or matrix composition comprising:
a) adding a required amount of a biologically active substance into a coating equipment, the biologically active substance being added in the form of crystals, granules, or a pregranulate of the biologically active substance and an excipient;
b) adding a premix of a matrix forming compound/component with an optional acid to the biologically active substance in the coating equipment of step (a);
c) Mixing the mixture of step (b) to uniformly distribute the premix on the biologically active substance;
d) Adding or spraying a hardening agent into the mixture of step (c) while mixing;
e) mixing the mixture of step (d) to obtain free flowing dry granules coated with a first coating of the rumen bypass coating or matrix composition embedding the biologically active substance.

13-23. (canceled)

24. The Rumen bypass coating or matrix composition according to claim 1, wherein the hardening agent is selected from the group consisting of calcium hydroxide, calcium oxide, magnesium hydroxide, and a mixture thereof.

25. The process according to claim 12, wherein the biologically active substance is added as a pregranulate of the biologically active substance and an excipient.

26. The process according to claim 11, wherein the matrix forming compound/component is selected from the group consisting of an oleoresin, spent oleoresin, an oleo gum resin, a gum resin, a resin, rosin, a lipid, a fat, fatty acids, fatty acid distillates, sludge, residue oil, oleoresin spent, mineral oils, vegetable oils, mother liquors, a wax, by-products of food and agricultural industries, and a mixture thereof.

27. The process according to claim 11, wherein the matrix forming compound/component is selected from the group consisting of palm fatty acid distillate, free fatty acids, palm stearin, and palm residue oil.

28. The process according to claim 11, wherein the hardening agent is selected from the group consisting of a metal/mineral hydroxide, a metal/mineral oxide, a metal/mineral carbonate, a metal/mineral chloride, a metal/mineral chelate, and a metal/mineral phosphate.

29. The process according to claim 11, wherein the acid is:
an organic acid selected from the group consisting of propionic acid, citric acid, fumaric acid, succinic acid, and maleic acid; or
an inorganic acid selected from the group consisting of hydrochloric acid and phosphoric acid.

30. The process according to claim 11, wherein the biologically active substance is selected from the group consisting of food/feed ingredients, pharmaceuticals, hormones, Biologics, phytochemicals, phytochemical containing components, vitamins, minerals, nutraceutical compounds/ingredients, nutritional compounds/ingredients, supplement/additives, animal extract, food ingredients, beverage ingredients, growth promoters, performance enhancers, omega-3 fatty acids, omega-6-fatty acids, proteins, amino acids, and mixtures thereof.

31. The process according to claim 11, wherein the active ingredient further comprises an excipient selected from the group consisting of wetting agents, flavors, sweeteners, dispersing agents, glidants, flow property enhancers, preservatives, stabilizers, pH stabilizers, anti-oxidants, aborption/bioavailability enhancers, emulsifiers, release control polymers, and mixtures thereof.

32. The process according to claim 11, further comprising a step of coating the first coating on the free flowing dry granules with at least one additional coating of the rumen bypass coating or matrix composition;
said step of coating the first coating comprising adding the free flowing dry granules to the coating apparatus, and repeating steps (b) through (f).

33. The process according to claim 12, further comprising a step of coating the first coating on the free flowing dry granules with at least one additional coating of the rumen bypass coating or matrix composition;
said step of coating the first coating comprising adding the free flowing dry granules to the coating apparatus, and repeating steps (b) through (e).

34. The process according to claim 11, wherein the rumen bypass coating or matrix composition is thermally stable.
